(19) United States
(12) Patent Application Publication
(10) Pub. No.: US 2024/0046683 A1
(43) Pub. Date: Feb. 8, 2024

(54) INTERACTIVE VOICE RESPONSE SYSTEMS HAVING IMAGE ANALYSIS

(71) Applicant: Nuance Communications, Inc., Burlington, MA (US)

(72) Inventors: Akash Chawla, Cambridge (CA); Jenny DeGroot, Palatine, IL (US); Sergey A. Vovk, Fair Lawn, NJ (US)

(73) Assignee: Nuance Communications, Inc., Burlington, MA (US)

(21) Appl. No.: 17/816,957

(22) Filed: Aug. 2, 2022

(51) Int. Cl. G06V 30/41; G06V 30/146; G06V 30/19; H04M 3/493; H04L 51/18; G10L 15/22

(52) U.S. Cl. CPC G06V 30/41; G06V 30/1463; G06V 30/19; H04M 3/4936; H04L 51/18; G10L 15/22

(57) ABSTRACT

An interactive voice response system is provided that includes an interactive voice recognition module, an image collection module, and a data extraction module. The image collection module communicates with the voice recognition module and the user device. The extraction module communicates with the image collection module. The voice recognition module collects speech data from a user of the user device and provides an indication to the image collection module when the speech data includes complex data. The image collection module, in response to the indication, communicates with the user device in a text message. The text message includes a link that, when activated, opens a camera on the user device. The image collection module, in response to receiving an image having the complex data from the camera, communicates the image to the extraction module, which extracts the complex data from the image as textual data.

### BACKGROUND

### 1. Field of the Invention

The present disclosure is related to interactive voice response systems. More particularly, the present disclosure is related to interactive voice response systems that include image analysis.

### 2. Description of Related Art

Systems that provide interactive voice response systems or IVR are automated telephone systems that allow incoming callers to access information via a voice response system of prerecorded messages without having to speak to an agent, as well as to utilize menu options via touch tone keypad selection or speech recognition to have their call routed to specific departments or specialists.

In some instances the IVR system are required to collect complex data such as, but not limited to, address, first name, last name, email address, healthcare member ID, claim numbers, internet router number, driver's license numbers, laptop service tags, and the like.

It has been determined by the present disclosure that prior IVR systems have not provided acceptable approaches to collecting such complex data, which often results in frustrated users requesting to speak with an operator in the call center. Thus, such complex data collection can increase the load on call center agents and impacts overall customer satisfaction score (CSAT) and average handle time (AHT).

Accordingly, there is a need for IVR systems that overcome, alleviate, and/or mitigate one or more of the aforementioned and other deleterious effects of the prior art.

### SUMMARY

An interactive voice response system is provided. The system includes an interactive voice recognition module, an image collection module, and a data extraction module. The interactive voice recognition module communicates with a user device via over a network. The image collection module communicates with the interactive voice recognition module and the user device over the network. The data extraction module communicates with the image collection module. The interactive voice recognition module collects speech data from a user of the user device and provides an indication to the image collection module when the speech data includes complex data. The image collection module, in response to the indication, communicates with the user device in a text message over the network. The text message includes a link that, when activated, opens a camera on the user device. The image collection module, in response to receiving an image having the complex data from the camera, communicates the image to the data extraction module. The data extraction module, in response to receiving the image, extracts the complex data from the image as textual data.

In some embodiments either alone or together with any one or more of the aforementioned and/or after-mentioned embodiments, the complex data is data that typically results in lower accuracy of collection via speech.

In some embodiments either alone or together with any one or more of the aforementioned and/or after-mentioned embodiments, the complex data is selected from a group consisting of an address, a first name, a last name, an email address, a driver license number, a passport number, a social security number, a vehicle identification number, a healthcare member identification number, a claim number, an internet router number, a laptop service tag, a credit card information, and any combinations thereof.

In some embodiments either alone or together with any one or more of the aforementioned and/or after-mentioned embodiments, the system further includes an operational module. The operational module communicates with the data extraction module so that the operational module receives the textual data from the data extraction module. The operational module communicates with the user device over the network based on the textual data.

In some embodiments either alone or together with any one or more of the aforementioned and/or after-mentioned embodiments, the operational module is a call routing module that routes the user to a particular responsible department and provides communication between the particular responsible department and the user device over the network.

In some embodiments either alone or together with any one or more of the aforementioned and/or after-mentioned embodiments, the operational module is a security module that uses the textual data as security information when communicating with the user device over the network.

In some embodiments either alone or together with any one or more of the aforementioned and/or after-mentioned embodiments, the text message is a message selected from a group consisting of a short message service (SMS) message, a multimedia messaging service (MMS) message, an over the top (OTT) message, and a rich communication service (RCS) message.

In some embodiments either alone or together with any one or more of the aforementioned and/or after-mentioned embodiments, the image collection module has a storage system that stores the image.

In some embodiments either alone or together with any one or more of the aforementioned and/or after-mentioned embodiments, the image collection module and/or the data extraction module is configured to orientation and/or rotate the image prior to extracting the complex data.

In some embodiments either alone or together with any one or more of the aforementioned and/or after-mentioned embodiments, the image includes multiple strings of data. The data extraction module parses the multiple strings of data into the textual data.

A method of operating an interactive voice response system is also provided. The method includes the steps of receiving speech data of a user, from a user device over a network, in an interactive voice recognition module; communicating, if the speech data includes complex data, to the user device via text message over the network, the text message including a link that, when activated, opens a camera on the user device; receiving an image having the complex data from the camera on the user device over the network; and extracting the complex data from the image as textual data.

In some embodiments either alone or together with any one or more of the aforementioned and/or after-mentioned embodiments, the user remains in communication from the user device over the network during the receiving and extracting steps.

In some embodiments either alone or together with any one or more of the aforementioned and/or after-mentioned embodiments, the complex data is selected from a group consisting of an address, a first name, a last name, an email address, a driver license number, a passport number, a social security number, a vehicle identification number, a healthcare member identification number, a claim number, an internet router number, a laptop service tag, a credit card information, and any combinations thereof.

In some embodiments either alone or together with any one or more of the aforementioned and/or after-mentioned embodiments, the method further includes the step of communicating with the user device via the network based on the textual data.

In some embodiments either alone or together with any one or more of the aforementioned and/or after-mentioned embodiments, the method further includes the step of routing the user to a particular responsible department and to provide communication between the particular responsible department and the user device via the network based on the textual data.

In some embodiments either alone or together with any one or more of the aforementioned and/or after-mentioned embodiments, the method further includes the step of using the textual data as security information when communicating with the user device via the network.

In some embodiments either alone or together with any one or more of the aforementioned and/or after-mentioned embodiments, the text message is a message selected from a group consisting of a short message service (SMS) message, a multimedia messaging service (MMS) message, an over the top (OTT) message, and a rich communication service (RCS) message.

In some embodiments either alone or together with any one or more of the aforementioned and/or after-mentioned embodiments, the method further includes the step of storing the image.

In some embodiments either alone or together with any one or more of the aforementioned and/or after-mentioned embodiments, the method further includes the step of orienting and/or rotating the image prior to extracting the complex data.

In some embodiments either alone or together with any one or more of the aforementioned and/or after-mentioned embodiments, the image includes multiple strings of data. The method further includes the step of parsing the multiple strings of data into the textual format.

The above-described and other features and advantages of the present disclosure will be appreciated and understood by those skilled in the art from the following detailed description, drawings, and appended claims.

### DESCRIPTION OF THE DRAWINGS

FIG. 1 is a schematic depiction of a first exemplary embodiment of an IVR system according to the present disclosure; and

FIG. 2 is a schematic depiction of a second exemplary embodiment of an IVR system according to the present disclosure.

### DETAILED DESCRIPTION

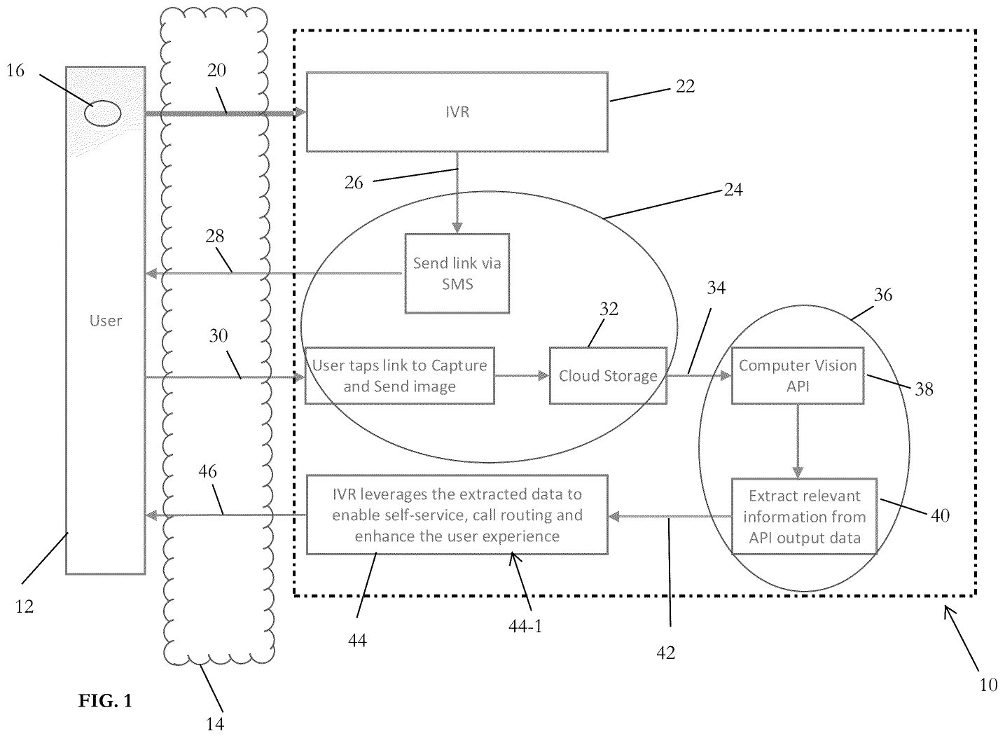

Referring to the drawings and in particular to FIG. 1, an exemplary embodiment of an interactive voice response (IVR) system according to the present disclosure is shown and is generally referred to by reference numeral 10.

Advantageously, IVR system 10 is configured to collect complex data from a user via analysis of a captured image of the user data. System 10 uses analysis including computer vision to extract data from the captured image. Thus, system 10 is configured to improve the ease, accuracy, and speed with which complex data is obtained from the user. Moreover, system 10 is configured to use the extracted data in a number of different ways to improve the user experience.

In some embodiments, system 10 uses the extracted data to route the call within the voice response system to a desired service department. In other embodiments either alone or in combination with the aforementioned call routing functionality, system 10 uses the extracted data as for enhanced security functionality, where the extracted data is challenge information for authentication in the system.

Referring now to FIG. 1, system 10 interfaces with a user device 12 via a network 14.

User device 12 can be any wired or wireless communication device that includes a camera 16 where the device is capable of voice communication and data communication, in particular of images from the camera, over network 14. For example, device 12 can be a smart phone, a tablet, a laptop, and others

Network 14 can be any wired or wireless communication network capable of voice communication and data communication with device 12. For example, network 14 can be cellular networks such as, but not limited Global System for Mobiles (GSMI) and Code Division Multiple Access (CDMA), wide area networks (WAN), local area networks (LAN) and others.

For ease of discussion, system 10 is described in detail below in use with device 12 in the form of a smart phone of the user and network 14 in the form of the cellular phone network of a provider contracted by the user.

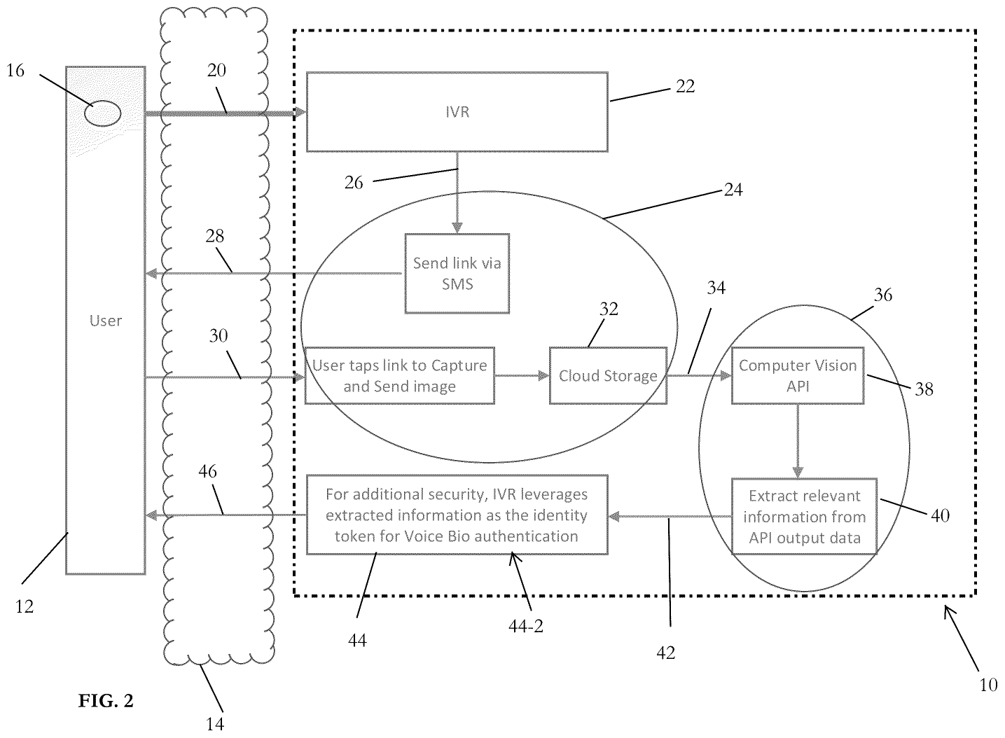

System 10 is described by way of the process or steps of interaction between device 12 of the user and the system—with simultaneous reference to FIGS. 1 and 2.

At a first step 20, the user communicates from device 12 over network 14 with an interactive voice recognition module 22. IVR module 22 is configured to collect information from the user. Module 22 is configured to collect speech data from the user and to interact with the user based on the speech data provided by the user.

The present application has determined that some information to be collected is in the form of complex data that typically results in lower accuracy of collection via speech—and can be provided by taking an image of a known source document. Some examples of complex data that can result in lower accuracy of collection and are available from source documents—include, but are not limited to, an address, a first and/or last name, an email address, a driver license or passport number, a social security number, a vehicle identification number, a healthcare member ID, a claim number, an internet router number, a laptop service tag, credit card information, and others.

Advantageously, system 10 is configured such that, based on the interaction with the user, when IVR module 22 determines that the information to be collected is in the form of such complex speech data, the system switches from voice recognition using module 22 to using an image collection module 24 at a second step 26.

In some instances, system 10 may first attempt to collect the information from the user using voice recognition—and may only pass the user on to image collection module 24 in the event that module 22 and/or the user detects an issue with the data collection process.

Once passed to image collection module 24, the module generates a link and sends the link to device 12 of the user in a message via network 14 in third step 28. The message and link can be a text message sent via known short message services (SMS). Of course, it is contemplated by the present disclosure for system 10 to send the message of third step 28 via other communication protocols such as, but not limited to, multimedia messaging services (MMS), over the top (OTT) services (e.g., iMessage, WhatsApp, Facebook Messenger, WeChat, etc.), rich communication services (RCS), and others.

The message of third step 28 includes a link that, when activated, opens camera 16 on device 12 of the user so that the user can take a photo of a desired data source. In the example where the user is communicating with a health care provider, image collection module 24 sends a link to the user at step 28 prompting the user to take a picture of their health care insurance card—that includes healthcare member identifying data such as, but not limited to user name, insured name, group number, policy number, effective date, and other data.

In a fourth step 30, system 10 is configured to receive into image collection module 24 from device 12, over network 14, the image taken by camera 16 at step 28. Image collection module 24 can, in some embodiments, store the image in a storage system 32.

In a fifth step 34, system 10 is configured to pass the image collected at fourth step 30, whether or not stored in storage system 32, to a data extraction module 36. Data extraction module 36 is configured to extract data from images. For example, module 36 can include a computer vision interface 38 that is configured, via optical character recognition, to extract data from the image into textual format 40.

In some embodiments, data extraction module 36 can make use of a Microsoft Azure Cognitive Service for Computer Vision that parses the image and extracts relevant information into textual data. In the example discussed above where the image is an image of health care insurance card, data extraction module 36 can extract the first and/or last name of the user, the first and/or last name of the insured, the group number, the policy number, the effective date, and any combinations thereof.

In another example, if the image collected by image collection module 24 is an image of a driver's license, data extraction module 36 can extract the user first and/or last name, a date of birth, an address, a driver's license number, and any combinations thereof.

In some embodiments, data extraction module 36 is configured to parse multiple strings of data (e.g., scanned card contains member ID, group, and plan). For example, it is contemplated by the present disclosure for data extraction module 36 to parse the multiple strings of data based on one or more regular expression (e.g., regex) rules based on the type of image provided.

In other embodiments, data extraction module 36 and/or image collection module can be configured to include orientation and rotation routines prior to extracting the data.

Importantly, system 10—by way of modules 22, 24, 26—collects one or more pieces of data in one or more images from the user and parses data from those images with higher accuracy and speed than would be possible using voice recognition only.

In a sixth step 42, system 10 is configured to pass the complex user data in textual format 40 to an operational module 44.

Operational module 44 is shown in FIG. 1 as call routing module 44-1 and is shown in FIG. 2 as a security module 44-2.

In the example of operational module 44 being in the form of call routing module 44-1, system 10 is configured to route the user's call to a particular responsible department and to provide communication between that department and the user at a sixth step 46 via network 14.

In the example of operational module 44 being in the form of security module 44-2, system 10 is configured to use the data extracted as a security token and to provide communication to the user including that token at the sixth step 46 via network 14.

Of course, it is contemplated by the present disclosure for system 10 to be configured such that operational module 44 has both call routing and security modules 44-1, 44-2, together or other operational modules.

It has been determined by the present disclosure that system 10 solves the problems related to complex data collection typically present in IVR only systems. Thus, system 10 increases ID and authentication rates and increases self-service such that a reduction of transfers due to recognition issues at complex data collection states and reduction in Agent Handle Time in the call center.

Moreover, system 10 results in digital data collection function that lets the user scan an item or document, while staying connected to the system via network 14. Stated differently, the user can remain on the call with system 10 while providing one or more images from camera 16 such that the system can extract their data to enhance the accuracy and reduce the speed of their user experience with the system.

System 10 creates an easy and highly accurate way to collect complex information in a short time while in communication with the user via network 14.

As used herein, the term “module” means a combination of software (e.g., program instructions stored on at least one non-transitory computer readable storage medium) and/or hardware (e.g., one or more processors and/or circuits configured to execute instructions), where such software and/or hardware interact with one another so as to provide system 10 with the functionality described above.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

### PARTS LIST

interactive voice response system 10
user device 12
network 14
camera 16
first step 20
interactive voice recognition module 22
image collection module 24
second step 26
third step 28
fourth step 30
storage system 32
fifth step 34
data extraction module 36
computer vision interface 38
textual format 40
sixth step 42
operational module 44
call routing module 44-1
security module 44-2
sixth step 46

What is claimed is:

1. An interactive voice response system, comprising:
an interactive voice recognition module configured to communicate with a user device via over a network;
an image collection module configured to communicate with the interactive voice recognition module and configured to communicate with the user device over the network; and
a data extraction module configured to communicate with the image collection module,
wherein the interactive voice recognition module is configured to collect speech data from a user of the user device, the interactive voice recognition module being configured to provide an indication to the image collection module when the speech data comprises complex data,
the image collection module is configured to, in response to the indication, communicate with the user device in a text message over the network, the text message including a link that, when activated, opens a camera on the user device,
the image collection module, in response to receiving an image having the complex data from the camera on the user device over the network, communicates the image to the data extraction module, and
the data extraction module is configured to, in response to receiving the image from the image collection module, extract the complex data from the image as textual data.

2. The system of claim 1, wherein the complex data is data that typically results in lower accuracy of collection via speech.

3. The system of claim 1, wherein the complex data is selected from a group consisting of an address, a first name, a last name, an email address, a driver license number, a passport number, a social security number, a vehicle identification number, a healthcare member identification number, a claim number, an internet router number, a laptop service tag, a credit card information, and any combinations thereof.

4. The system of claim 1, further comprising an operational module configured to communicate with the data extraction module so that the operational module receives the textual data from the data extraction module, wherein the operational module is configured to communicate with the user device over the network based on the textual data.

5. The system of claim 4, wherein the operational module is a call routing module, the call routing module being configured to route the user to a particular responsible department and to provide communication between the particular responsible department and the user device over the network.

6. The system of claim 4, wherein the operational module is a security module, the security module being configured to use the textual data as security information when communicating with the user device over the network.

7. The system of claim 1, wherein the text message is a message selected from a group consisting of a short message service (SMS) message, a multimedia messaging service (MMS) message, an over the top (OTT) message, and a rich communication service (RCS) message.

8. The system of claim 1, wherein the image collection module further comprises a storage system, the image collection module being configured to store the image in the storage system.

9. The system of claim 1, wherein the image collection module and/or the data extraction module is configured to orientation and/or rotate the image prior to extracting the complex data.

10. The system of claim 1, wherein the image comprises multiple strings of data, the data extraction module being configured to parse the multiple strings of data into the textual data.

11. A method of operating an interactive voice response system, comprising:
receiving speech data of a user, from a user device over a network, in an interactive voice recognition module;
communicating, if the speech data comprises complex data, to the user device via text message over the network, the text message including a link that, when activated, opens a camera on the user device;
receiving an image having the complex data from the camera on the user device over the network; and
extracting the complex data from the image as textual data.

12. The method of claim 11, wherein the user remains in communication from the user device over the network during the receiving and extracting steps.

13. The method of claim 11, wherein the complex data is selected from a group consisting of an address, a first name, a last name, an email address, a driver license number, a passport number, a social security number, a vehicle identification number, a healthcare member identification number, a claim number, an internet router number, a laptop service tag, a credit card information, and any combinations thereof.

14. The method of claim 11, further comprising communicating with the user device via the network based on the textual data.

15. The method of claim 11, further comprising routing the user to a particular responsible department and to provide communication between the particular responsible department and the user device via the network based on the textual data.

16. The method of claim 11, further comprising using the textual data as security information when communicating with the user device via the network.

17. The method of claim 11, wherein the text message is a message selected from a group consisting of a short message service (SMS) message, a multimedia messaging service (MMS) message, an over the top (OTT) message, and a rich communication service (RCS) message.

18. The method of claim 11, further comprising storing the image.

19. The method of claim 11, further comprising orienting and/or rotating the image prior to extracting the complex data.

20. The method of claim 11, wherein the image comprises multiple strings of data, the method further comprising parsing the multiple strings of data into the textual format.
